(19) United States
(12) Patent Application Publication
(10) Pub. No.: US 2008/0177771 A1
(43) Pub. Date: Jul. 24, 2008

(54) METHOD AND SYSTEM FOR MULTI-LOCATION COLLABORATION

(75) Inventor: Garfield W. Vaughn, South Windsor, CT (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/624,834

(22) Filed: Jan. 19, 2007

(51) Int. Cl. G06F 15/16; G06F 17/30

(52) U.S. Cl. 707/102; 709/205; 707/E17.044

(57) ABSTRACT

Disclosed are a method and system of conducting multi-location collaboration. The method comprises the steps of establishing a collaboration session among the multiple remote users, each of the users having a respective white board; and during the collaboration session, said multiple users exchanging audio, video, text and graphics among the multiple users via the white boards, said collaboration session including branching points and collaboration output between the branching points. The method comprises the further steps of defining each of the branching points as a respective one node, and recording nodes and segments of the collaboration session in near real time. Also, replay of any of the collaboration segments is enabled, said replay comprised of audio, video, text and graphics, and relationships among the nodes and the segments are graphically rendered.

### BACKGROUND OF THE INVENTION

1. Field of the Invention

This invention generally relates to real time interactive communication between remote users.

2. Background Art

Over the past several years, there has been a trend within many industries of employees working remotely. The International Telework Association and Council (ITAC) has been conducting surveys on teleworkers in the US since 1995 and estimates 23.5 million employed Americans worked from home during business hours at least one day per month in 2003. JALA International, in association with ITAC, forecasts over 40 million teleworkers in the US by 2010. The US Bureau of Labor Statistics reports there were 138.5 million employed Americans in March 2004. This report estimates that 19.2% of these Americans, or 26.6 million, worked at home in their primary job at least once a month.

The need to collaborate across a team, the members of which work in a remote manner, is growing. There is a growing need to be able to have a meeting with remote team members who would be able to see in real time what each other is working on and also be able to edit it.

Collaboration, in general, involves creating and displaying text and graphics and then sharing the information created with each collaborator in real or substantially real time. This sharing may be facilitated by a system, which provides a common shared work space. Working without a shared work space can limit collaboration by delaying the common understanding about a thing, task, etc. being referred to, limiting the ability of one collaborated to visually add to or comment on the work of another collaborator, causing significant delays in the chain of communication between the collaborators, etc.

There exists in the art a number of devices or systems allowing or facilitating various degrees of use of a shared work space. Some for example, allow remote users only to use the work space. For example, U.S. Pat. No. 4,400,724 issued to Fields teaches presenting images of both a user and a document or the like, and allowing some degree of interactive use of the document. Fields discloses a video teleconferencing system where a number of collaborators can interactively communicate via a plurality of interconnected monitors and cameras. A document is imaged by a video camera suspended above a target area where the document is located. Likewise, gestures related to the document made within the target area are imaged by the same video camera. The images are presented on the monitors of other collaborators. The other collaborators may modify the image by marking over their own target areas or referred to the image by gesturing in the appropriate locations in their own target area. The composite of the document's image modifications and gestures are distributed for viewing by collaborators on their monitors, which are physically separate from their target areas, in real time.

Other collaborative systems use computer monitors only. Consequently, these systems make it more difficult for collaborators to quickly alter the collaborative subject matter.

While existing collaboration systems have a number of advantages, there is, as mentioned above, a growing need to be able to have a meeting with remote team members who would be able to see in real time what each other is working on and also be able to edit it.

### SUMMARY OF THE INVENTION

An object of the present invention is to provide an improved method and system to conduct multi-location collaboration.

Another object of the invention is to enable a meeting with remote team members each of whom is able to see and to edit in real time what each of the others is working on.

A further object of the instant invention is to allow each user of a multi-location collaboration to define collaboration segments and to render a graphical view of relationships of nodes of the collaboration.

These and other objectives are attained with a method and system of conducting multi-location collaboration. The method comprises the steps of establishing a collaboration session among the multiple remote users, each of the users having a respective white board; and during the collaboration session, said multiple users exchanging audio, video, text and graphics among the multiple users via the white boards, said collaboration session including branching points and collaboration output between the branching points. The method comprises the further steps of defining each of the branching points as a respective one node, and recording nodes and segments of the collaboration session in near real time.

One of the multiple users gains exclusive control of the collaboration session at any given time, wherein information input to the white board of said one of the multiple users, while said one of the multiple users has said exclusive control, is distributed to one or more of the other users in near real time. Also, replay of any of the collaboration segments is enabled, said replay comprised of audio, video, text and graphics, and relationships among the nodes and the segments are graphically rendered.

The preferred embodiment of the invention uses a touch screen device the size of a normal “White Board” that allow remote users to connect and collaborate in real time. The methods used to support this device allow a user to write/draw/erase information with special input devices.

The touch screen display sends and receives information over a network (Internet) and allows multiple remote to share and collaborate. A user who is part of a conference with one of these devices is able to see the information being created by others, take control and make changes, which are immediately seen by all participants. Each user has the ability to save, e-mail, print and/or fax, the images (multiple pages).

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 schematically illustrates a collaboration system embodying the present invention.

FIG. 2 shows an apparatus for writing and displaying data and that may be used in the collaboration system of FIG. 1.

FIG. 3 is a block diagram of a circuit for transmitting and receiving data scribed on a writing and displaying device for collaborative communication according to the present invention.

FIG. 4 shows a collaboration flow.

FIG. 5 illustrates nodes and segments of a collaboration session.

FIG. 6 shows an architecture for node and segment definition in a multi-user collaboration session.

### DETAILED DESCRIPTION OF THE PREFERRED EMBODIMENTS

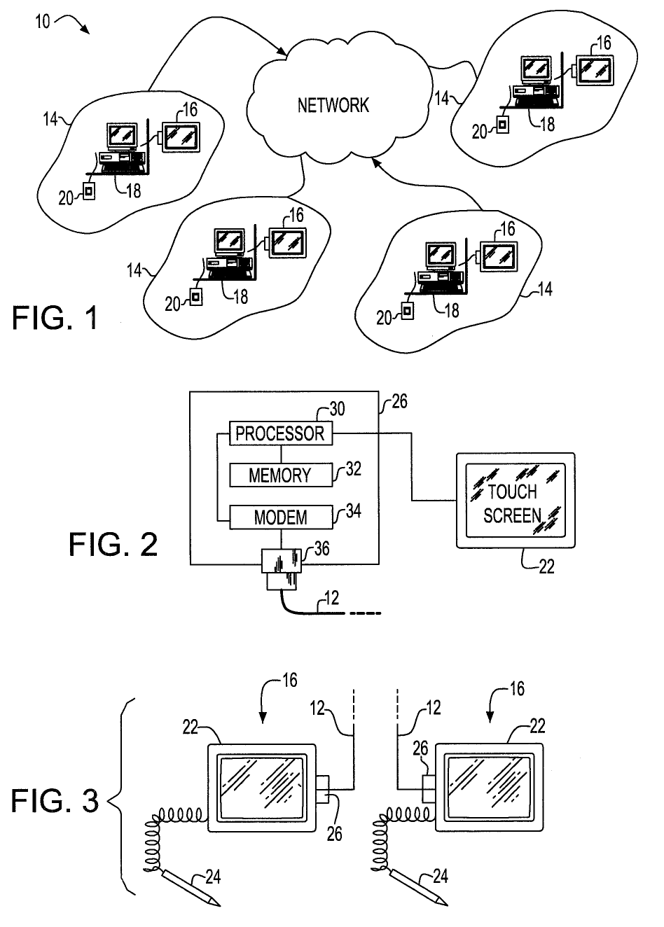

Referring now to FIG. 1, a system 10 for remote collaboration is illustrated according to the present invention. System 10 includes a communication network 12 for transmitting collaborative information between users of the system. The communication network 12 is connected to a plurality of user sites.

Communication network 12 is preferably, but not necessarily, the Internet, and the individual user sites 14 are connected to network 12 in any suitable way.

As will be appreciated by those of ordinary skill in the art, other types of communication networks may be used in the practice of this invention; and, for instance, a WAN or a LAN that does not use the Internet may be employed. Also, a telephone network or a cable television network may be used in this invention.

Each of the user sites 14 contain a collaborative writing/display device 16 according to the present invention. The collaborative writing/display device 16 may be connected to a computer 18 or to a telephone jack 20 in communication with the communication network 12.

Referring now to FIG. 2, the collaborative writing/display device 16 for writing and displaying collaborative data is illustrated according to the present invention. In one embodiment of the present invention apparatus 16 includes a touch sensitive screen 22, a stylus 24 and a network interface unit 26. Touch sensitive screen 22 is responsive to contact by the stylus 24. The stylus is mechanically attached to screen 22 and does not require electrical communication with the screen. Collaborative data as referenced in the present application is data in the form of digital bits created by contacting the stylus 24 to the touch sensitive screen 22. For example, a figure or graphic may be created on the touch sensitive screen 22 by contacting the touch sensitive screen 22 with the stylus 24 and dragging the stylus across the screen to create different shapes. In a similar manner, handwritten text may be created. Whatever is written on the screen 22 will be transmitted via the network interface unit 26 to the communication network 12. Network interface unit 26 allows the writing/display device 16 to connect to and transmit collaborative data directly across the communications network without connecting to computer 18.

A more detailed diagram of the network interface unit 26 is illustrated in FIG. 3, according to the present invention. The network interface unit 26 includes a processor 30, memory 32 and a modem 34. Processor 30 is connected to the touch sensitive screen 22, memory 32 and the modem 34. Processor 30 controls the flow of collaborative data written and displayed on the touch sensitive screen 22. For example, collaborative data created by a user of the screen 22 is sent to memory 32 where it is temporarily stored until it can be transmitted by the modem 34. The processor 30 being connected to memory 32 directs the collaborative data from the screen 22 to the memory 32. Modem 34 is capable of receiving the collaborative data from the processor 30 and transmitting the data over the communication network via a network connector 36.

If the writing/display device 16 is connected to the computer 18 instead of directly to the telephone jack 20 the network interface unit 26 may be inactivated. The control of transmission and reception of collaborative data would be handled by the computer 18. When transmitting data across a network of computers such as the Internet standard networking protocols may be used.

In operation, collaborative data is transmitted by a first writing display device 16 to a second remote writing/display device by activating the former device and using the associated stylus to create a graphic or handwritten text on the device. In order to receive this information, the second writing/displaying device must be activated. Once the appropriate connection between the devices is achieved, collaborative data are transmitted between the devices and shown on the display screens.

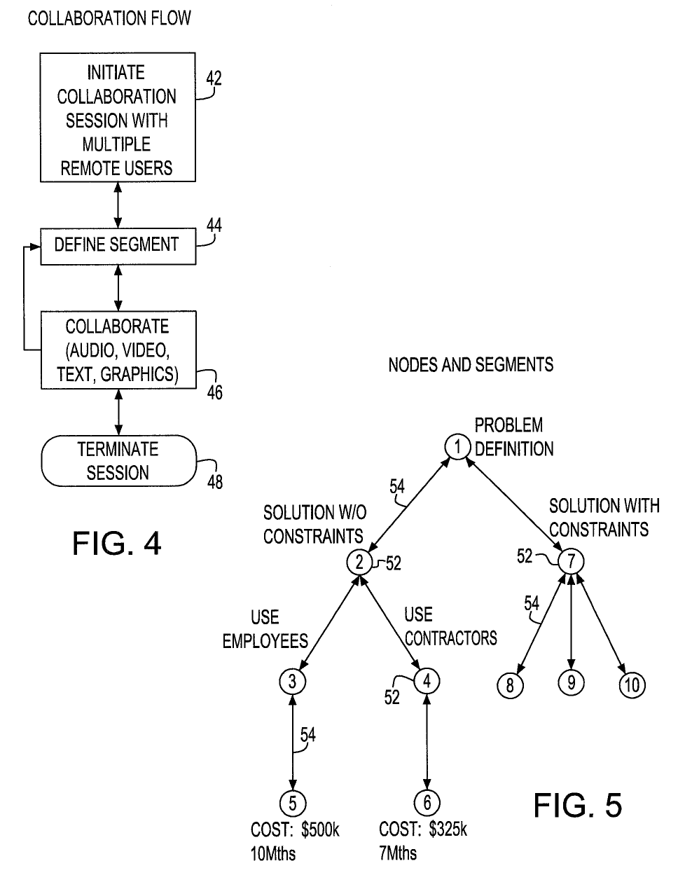

FIG. 4 illustrates the collaboration flow. At step 42, a collaboration session is initiated with multiple remote users; and at step 44, collaboration segments are defined. Then, at step 46, the remote users collaborate via audio, video, text and graphics; and after this, the collaboration, the session terminates at step 48.

FIG. 5 is a graphical representation of the nodes 52 and segments 54 of a collaboration session. A node is a branch point (bookmark) that has a unique identifier, user description label, date and time stamp. Some nodes will have predecessor relationships. A segment is a connection between two nodes.

As an example, assume node 6 is selected as the option to implement. All other routes may have some value, but route 1->2->3->6 is the preferred route. Any one can now easily review the flow and have a very good understanding about how that option/decision came about. Preferably, the system will graphically render node/segment relationships using user defined descriptive terms. Also, the invention provides the ability to replay only a selected segment or the selected segment and all predecessor segments.

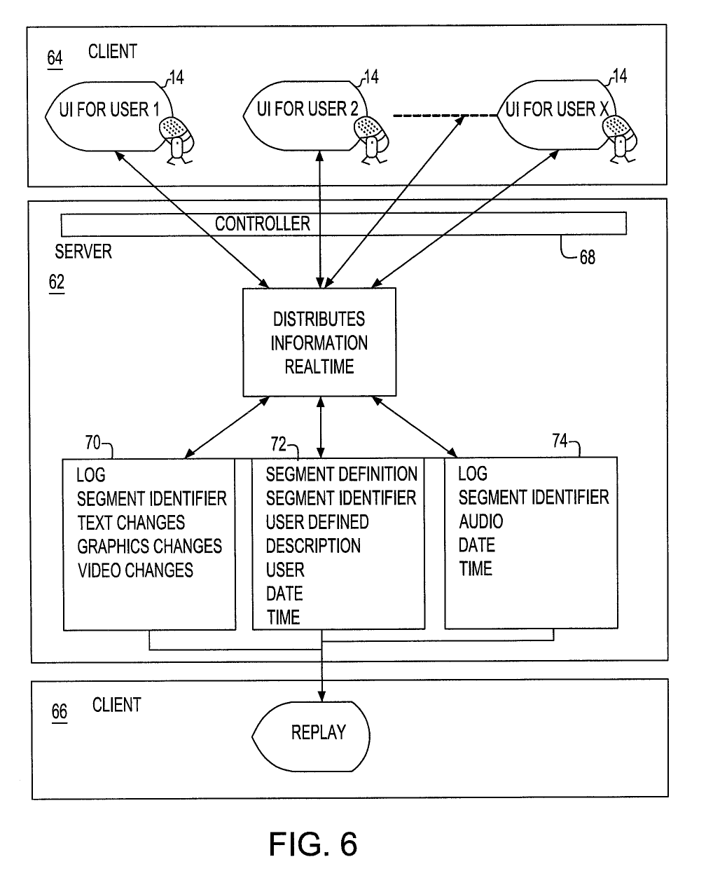

FIG. 6 shows an architecture for node and segment definition in a multi-user collaboration session. In particular, FIG. 6 shows a server 62 and two clients 64 and 66. Each of the users 14 is part of client 64, and each user has a respective user interface. Server 62 includes a controller 68 that receives and processes the information received from the users, and the server distributes the information back to the users in real time.

In addition, server maintains several databases 70, 72 and 74. Database 70 is a first log that logs in each segment and the changes made during that segment. In particular, each segment is logged in by entering the segment identifier and identifying the text graphics and video changes made during the segment. Database 72 is used to store other information about the segments of a collaboration session. Specifically, for each segment, this database is used to store the segment identifier and the segment definition. Each user and the date and time of the segment are also stored in this database. Database 74 is another log that stores the audio portion of each segment. In this database, each segment is logged in by entering the segment identifier and the audio portion of the segment. Preferably, the date and time of the segment are also stored in the database.

Client 66 is used to replay the segment of the session, using information from databases 70, 72 and 74.

The preferred embodiment of the invention, as described above in detail, provides a number of important features. Each user has the ability to retrieve/view other pages without affecting the commonly shared page, and each user has the ability to bookmark points in time that can be retrieved for future reference. Also, all changes are logged in, and associated with a user, date and time stamp. This is essentially a recording feature.

In addition, the invention provides the ability to select a bookmark and branch to a new flow/solution. Each branch has its own identifier, allowing each discretely defined collaboration section to be graphically represented. The invention also provides the ability to replay each flow, and the images may be marked up once the conference is over.

As will be readily apparent to those skilled in the art, the present invention, or aspects of the invention, can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of conducting multi-location collaboration among multiple remote users, comprising the steps of:
establishing a collaboration session among the multiple remote users, each of the users having a respective white board;
during the collaboration session, said multiple users exchanging audio, video, text and graphics among the multiple users via the white boards, said collaboration session including branching points and collaboration output between the branching points;
defining each of the branching points as a respective one node;
recording nodes and segments of the collaboration session in near real time;
one of the multiple users gaining exclusive control of the collaboration session at any given time, wherein information input to the white board of said one of the multiple users, while said one of the multiple users has said exclusive control, is distributed to one or more of the other users in near real time;
enabling replay of any of the collaboration segments, said replay comprised of audio, video, text and graphics; and
graphically rendering relationships among the nodes and the segments.

2. A method according to claim 1, wherein the step of exchanging audio, video, text and graphics includes the step of each of the users sending the audio, video, text and graphics to a common server.

3. A method according to claim 2, wherein the step of exchanging audio, video, text and graphics includes the further step of said common server sending to each of the users all of the audio, video, text and graphics received by said common server.

4. A method according to claim 1, comprising the further step of storing in a first data base a respective one record for each of the segments, wherein the record for each segment includes an identifier of the segment, and changes to the text, graphics and video made during the segment.

5. A method according to claim 4, comprising the further step of storing in a second database a respective one further record for each of the segments, wherein the further record for each segment includes an identifier of the segment and the audio of said segment.
